(19) United States
(12) Patent Application Publication
(10) Pub. No.: US 2025/0125565 A1
(43) Pub. Date: Apr. 17, 2025

(54) Shielding Sleeve For A Plug Connector

(71) Applicant: HIRSCHMANN AUTOMOTIVE GMBH, Rankweil/Brederis (AT)

(72) Inventor: Lukas BREUSS, Feldkirch (AT)

(21) Appl. No.: 18/834,770

(22) PCT Filed: Mar. 7, 2023
(86) PCT No.: PCT/EP2023/055766

§ 371 Date: Jul. 31, 2024

(30) Foreign Application Priority Data
Mar. 11, 2022 (DE) 10 2022 105 752.6

(51) Int. Cl. H01R 13/6592; H01R 43/20

(52) U.S. Cl. CPC H01R 13/6592; H01R 43/20

(57) ABSTRACT

The invention relates to a plug connector and a method for installing a plug connector, said plug connector having a contact support. The contact support has at least one contact chamber, in particular precisely two contact chambers, optionally more than two contact chambers, and a contact partner is inserted into each contact chamber, the position of the contact partner in the contact chamber being fixed, wherein the plug connector has a housing into which the contact support is inserted, and a shielding sleeve is coaxially arranged between the housing and the contact support. The shielding sleeve has at least one crimping geometry, and a first region of the shielding sleeve is separated from a second region in the region of the crimping geometry. In order to secure the shielding sleeve on the contact support, the aforementioned region is deformed relative to the second region.

The invention relates to a plug connector and a method for installing a plug connector according to the features of the respective preamble of the two independent patent claims.

Such plug connectors are known. The plug connector has a contact support. The contact support has at least one contact chamber, in particular precisely two contact chambers, optionally more than two contact chambers, wherein a contact partner is inserted into each contact chamber and is fixed in its position in the contact chamber, for example, locked. In addition, the plug connector has a housing (plug housing) into which the contact support is inserted. For shielding purposes, a shielding sleeve is arranged coaxially between the connector housing and the contact support.

The invention is based on the object of improving a known plug connector and a method for installing a plug connector with regard to its manufacture, its installation and its durability in operation.

This object is achieved by the features of the two independent patent claims.

With regard to the plug connector, it is provided according to the invention that the shielding sleeve has at least one crimping geometry, wherein a first region of the shielding sleeve is separated from a second region in the region of the crimping geometry. At least one part of the shielding sleeve is provided with the crimping geometry before it is attached to the contact support. For the simplest realization of the crimping geometry, both regions are formed by the material of the shielding sleeve. This crimping geometry is designed in such a way that the shielding sleeve can be pushed over the contact support (and, optionally, over a cable on which the contact support is arranged). If the shielding sleeve is arranged in its intended position on the contact support, part of the crimping geometry is deformed so that the shielding sleeve is permanently and securely fixed to the contact support. This means that the shielding sleeve can be manufactured very easily and then also installed very easily. By fixing the shielding sleeve to the contact support after deforming a part of the improvement contribution, a very permanent securing of these two parts to one another is also effected, so that the contact carrier can no longer move out of the shielding sleeve.

In a further development of the invention, it is provided that the separation of the two regions is a shear. Since both regions of the crimping geometry are formed by the material of the shielding sleeve for the simplest possible realization, the shielding sleeve is processed in such a way that the initially continuous material of the shielding sleeve is separated from one another by shearing. This does not involve material removal, but separation. In order to achieve this separation, it is first necessary to use tools to act on the shielding sleeve in such a way that the two regions are separated from one another. However, this means that at least one of the regions, and possibly both regions, are no longer in the same initial plane, but have moved out of it. For the subsequent installation and securing of the shielding sleeve to the contact support, it is therefore necessary for both regions, that have been moved out of the original plane to cause the shear, to be completely or almost completely reshaped into the original plane. After separation by means of the shearing process and reshaping, a shielding sleeve is available which again has an almost or completely continuous surface in the region of the crimping geometry, but now with a separation of the two regions. As an alternative to the shearing described above, which has the advantage that no material is removed and therefore no slot is created in the shielding sleeve, it can be considered to achieve separation by material removal. This can involve such processes as sawing or milling, a separation process using a laser or the like. However, this creates a slot between the two opposite end faces of the now separated regions of the crimping geometry. This also allows for a locking securing of the shielding sleeve on the contact support. This will be considered if the high-frequency properties of the plug connector are not significant or only play a minor role. The reason for this is that the slot generally allows electromagnetic radiation to enter or exit the plug connector. In contrast, the separation of the two regions in the region of the crimping geometry by means of shearing means that no or almost no slot is created, so that the high-frequency properties of such a plug connector are significantly improved.

In a further development of the invention, it is provided that the crimping geometry is distributed multiple times over the circumference of the shielding sleeve. This has the advantage that the shielding sleeve is even more securely locked onto the contact support. The crimping geometry can thus be present twice, three times, ideally four times, but optionally also more than four times, distributed over the circumference of the shielding sleeve. The crimping geometries can be provided in the course of a single revolution, but optionally, axially offset revolutions with crimping geometries arranged one behind the other or also offset from one another may also be considered. In the aforementioned cases, the outer surface of the contact support is adapted according to the number and arrangement of the crimping geometries, so that, for example, each deformed region of the crimping geometries can be deformed into its own cutout, its own circumferential groove or the like in the contact support in order to achieve the locking connection between the shielding sleeve and the contact support.

In a further development of the invention, it is provided that the plug connector is arranged at the end of a cable, wherein an end region of the shielding sleeve is arranged, preferably crimped, around an end region of the cable. Thus, the shielding sleeve is suitable and designed to connect the end region of the cable to the contact support. Advantageously, such a connection provides tension and/or pressure relief for the contact partners arranged in the contact support. In addition, the substantially cylindrical (optionally with two or more increments) shielding sleeve improves the stability of the plug connector.

In a further development of the invention, it is provided that the cable has a shield, wherein the shielding sleeve encloses the shielding at least partially, in particular completely. In such a case, the shielding sleeve is made of a metallic material, so that the closure of the shielding from the shielding sleeve and the associated electrical contact achieve further shielding of the plug connector. If the cable is a shielded cable and further shielding is not required, the shielding sleeve can alternatively be made of an electrically non-conductive material, such as plastic.

In a further development of the invention, it is provided that the housing is locked by at least one crimping geometry between the shielding sleeve and the contact support. After the shielding sleeve has been installed and secured to the contact support (and optionally to the end of the cable), the plug connector housing is installed. A further crimping geometry is provided for this installation, which ensures that the housing is secured to the shielding sleeve in a locking manner. Alternative fastenings of the housing to the shielding sleeve can also be considered. Such fastenings include, for example, crimping, gluing, or the like.

In a further development of the invention, it is provided that the shielding sleeve has at least one stud on its outer surface as a crimping geometry. One or more of such studs protrude outwards over the surface of the shielding sleeve and cause the housing to be crimped against the shielding sleeve. In the case of a shielding sleeve made of metallic material, such studs can be produced quickly and easily by deforming using a punch. Instead of studs, ribs, tabs, circumferential beads, and the like protruding from the shielding sleeve can also be considered. At this point, it should be mentioned that the shielding sleeve alternatively has a smooth continuous surface in the direction of the inner contour of the housing in such a way that the shielding sleeve does not have any protruding geometries (such as the studs or the like described above) for securing the housing pushed onto the shielding sleeve, as such geometries cause the housing to be tensioned on the shielding sleeve and could thus lead to damage or complete failure of the plug connector during operation as a result of the mechanical tension, such as breakage of the housing).

With regard to the method for installing a plug connector, it is provided according to the invention that the shielding sleeve has at least one crimping geometry, wherein a first region of the shielding sleeve is separated from a second region in the region of the crimping geometry, wherein in order to secure the shielding sleeve on the contact support, the aforementioned region is deformed relative to the second region. As already stated above with regard to the plug connector itself, by deforming at least one region, or optionally both regions, of the crimping geometry after separation, a locking edge is produced which interacts with a corresponding geometry of the contact support in order to secure the shielding sleeve to the contact support quickly, easily, and most importantly, permanently. It is conceivable that one region is deformed (and optionally also reshaped), and the other region retains its shape, which corresponds to the shape of the shielding sleeve in the region of the crimping geometry, after separation. In addition, the other region, i.e. both regions, can be deformed (and optionally also reshaped). The deformations (and optionally also the reshaping) of the two regions can be the same or different.

In a further development of the invention, it is provided that the separation of the two regions is achieved by shearing the material of the shielding sleeve. This shearing has the advantage that the initially continuous material of the shielding sleeve is separated from one another in certain regions without any material being removed. As already explained above, this has a beneficial effect on the high-frequency properties of a plug connector with such a shielding sleeve.

In a further development of the invention, it is provided that the separation of the two regions is achieved by removing the material of the shielding sleeve. This is an alternative way of separating an initially continuous region of the shielding sleeve in order to realize the crimping geometry. This alternative way is particularly suitable if the high-frequency properties of a plug connector with such a shielding sleeve are not important or only of secondary importance. However, this alternative way is not ruled out even if the high-frequency properties of the plug connector are important. In such cases, care must be taken to ensure that the slot created by material removal between the two regions of the crimping geometry is kept as small as possible.

In a further development of the invention, it is provided that, after the two regions have been separated, the deforming takes place in such a way that the mutually facing end surfaces of the two regions still partially overlap. This has the advantage that the mutually facing end faces of the two regions ideally do not form a slot or opening at all, or that this slot or opening is so small that complete or almost complete shielding is nevertheless provided by the shielding sleeve in this region, while at the same time the shielding sleeve is secured to the contact support in a locking manner. This deformation of one of the two regions or both regions thus has a simultaneous effect on the shielding as well as on the securing of the shielding sleeve to the contact support.

In the following, the embodiment of the invention is described once again in other words:

According to the invention, locking of the connector housing is effected by at least one crimping geometry between the shielding sleeve and the contact support, taking into account EMC requirements as well as sealing and tolerance influences.

The basis of the locking is created by shearing/slots in the shielding sleeve, wherein the regions are not deflected in their as-delivered condition. This makes it possible to install it on the contact support without any additional exertion of force.

The shielding sleeve is then pressed into corresponding recesses (e.g. cutouts) in the contact support before or after the locking regions. This fixes the internal contact support in place in a form-fitting manner and generates the locking edge for the connector housing.

The connector housing is then pushed on, preferably with a rounded hook geometry, and secured against deflection by a locking ring. This creates a tolerance-independent and form-fit connection with minimal locking overlap.

Due to the minimal locking overlap, the EMC properties are not impaired. The sealing region is no longer subjected to mechanical stress, thus permanently ensuring the tightness of the interior of the plug connector.

Embodiments of the plug connector according to the invention, as well as the steps of installing its elements, are shown in the figures. Information on angles, tolerances, and, if applicable, other dimensions are purely exemplary and not restrictive.

In the following, the idea according to the invention is explained in more detail using an exemplary embodiment and is described with reference to the figures

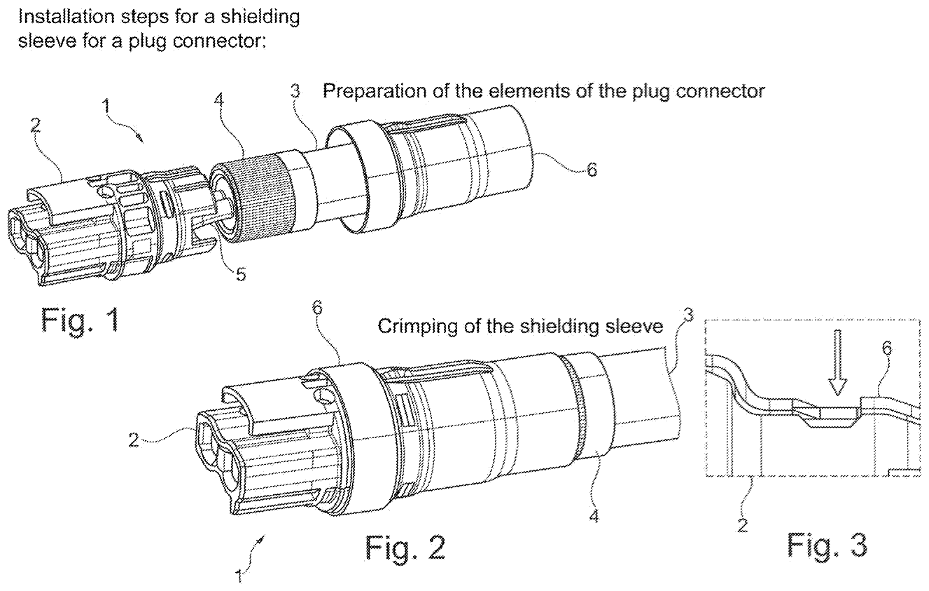

FIGS. 1 to 12 show a plug connector 1 according to the invention in different views along with its elements.

In FIG. 1, the plug connector 1 has a contact support 2, wherein the contact support 2 is connected to a cable 3. Cable 3 is a shielded cable, and has a shielding 4 within its outer sheath. A dielectric is arranged within the shielding 4, which surrounds at least one line 5 with an electrical conductor. In the exemplary embodiment, there are exactly two lines 5, each of which comprises an electrical conductor, wherein the electrical conductor is arranged on a contact partner, and each contact partner is arranged and secured within a contact chamber, which is formed by the contact support 2. While a shielded cable 3 is shown in the exemplary embodiment, it can also be a single or multiple unshielded cable. Furthermore, a shielding sleeve 6, preferably made of a metallic material or alternatively of an electrically non-conductive material, is shown being pushed onto the cable 3 from the left before the contact support 2 is installed, as seen in FIG. 1.

FIG. 2 shows that the shielding sleeve 6 has been pushed further over cable 3 and accommodates an end region of the contact support 2 in its left end (as seen in FIG. 2). In the other end region, the shielding 4 protrudes from the shielding sleeve 6. However, the length of the shielding 4 above the outer sheath of the cable 3 can also be dimensioned such that the shielding 4 does not protrude from one end of the shielding sleeve 6.

FIG. 3 shows that by crimping in the direction of the arrow, a subregion of the shielding sleeve 6 is deformed to form a locking edge, wherein this locking edge interacts with a corresponding edge formed by the outer contour of the contact support 2. This is described in more detail below.

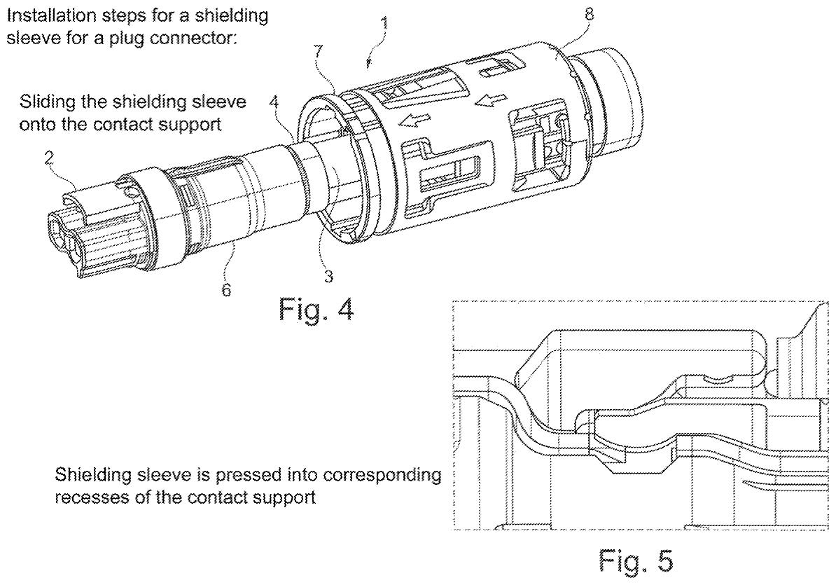

FIG. 4 shows that the prepared plug connector 1 according to FIG. 2 is provided with a housing 7. To complete the plug connector 1, the housing 7 is pushed further to the left in the direction of the contact support 2, as shown in FIG. 4. The housing 7 is secured to the shielding sleeve 6 by crimping, locking, gluing, or the like. Alternatively or additionally, a shielding cage 8 is provided, which either secures the housing 7 to the shielding sleeve 6 and/or interacts with a mating plug connector. The shielding cage 8 is preferably made of a metallic material, but can alternatively also be made of an electrically non-conductive material, such as plastic. This shielding cage 8 may be present, but does not have to be present. If this element does not have a shielding function, it can also be referred to as a locking element or locking sleeve and, as already mentioned above, it interacts with a mating plug connector to secure the mated plug connection (in order to prevent it from being unintentionally unplugged) as a securing element (also referred to as CPA: Connector Position Assurance). Even if this element does not have a shielding function, it can still be made of a metallic material.

As shown in FIG. 5, subregions of the shielding sleeve 6 are pressed into corresponding recesses (such as depressions, circumferential grooves, or the like) of the contact support 2 when a corresponding subregion of the shielding sleeve 6 is deformed by applying pressure in the direction of the arrow towards the recesses of the contact support 2.

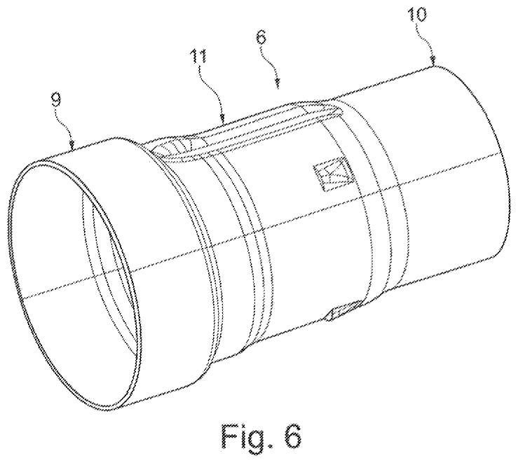

In FIG. 6, the shielding sleeve 6 is shown in detail. It is designed as a multi-stepped, substantially cylindrical component. This component comprises a front end 9, into which an end region of the contact support 2 is inserted and secured (see FIGS. 1 and 2). Such securing can also be achieved by crimping, gluing, locking, or the like. Opposite the front end 9, there is a rear end 10, with which the shielding sleeve 6 is pushed over the cable 3. The rear end 10 can be, but does not have to be, used to secure the shielding sleeve 6 onto the cable 3. This can also be effected, for example, by gluing, crimping, and, optionally, with the aid of other elements by locking. Between the two ends 9 and 10 there is a central region 11 of the shielding sleeve 6.

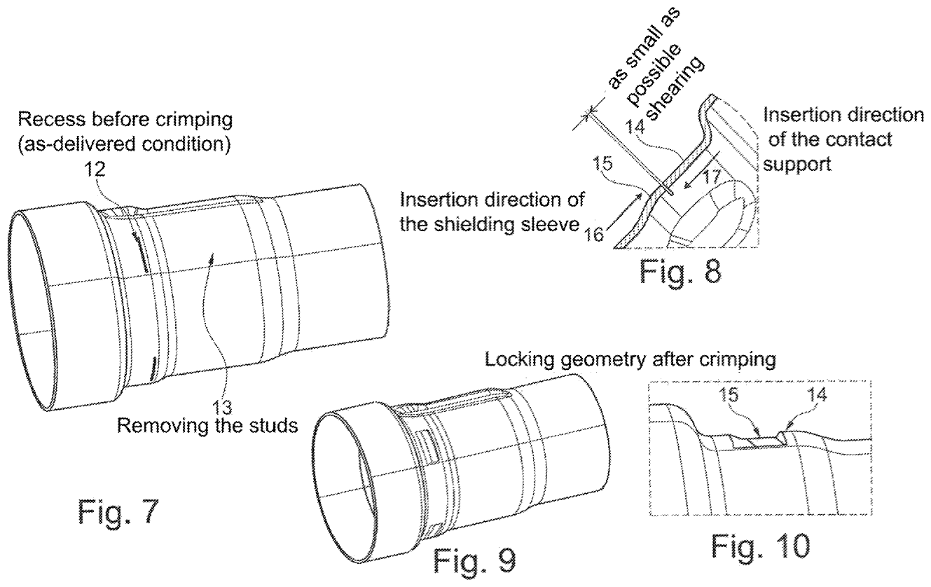

FIG. 7 shows a crimping geometry 12 according to the invention, which is arranged approximately in the transition between the front end 9 and the central region 11. At least one stud 13 can be present in the central region 11. While this stud 13 is still present in FIG. 6, it has been removed in FIG. 7. This makes it possible to push the housing 7 over the shielding sleeve 6 with almost no play and no force. This prevents the housing 7 from jamming when pushed over the shielding sleeve 6. In addition, no forces are transferred to the housing 7 after the push-over process has been completed. This is particularly important if the shielding sleeve 6 is made of a rigid metal material, whereas the housing 7 is made of a plastics material.

With reference to FIGS. 8 to 10, the crimping geometry 12 according to the invention is explained in more detail. Here, it is directly recognizable as a substantial feature of the invention that the shielding sleeve 6 has at least one crimping geometry 12, wherein in the region of the crimping geometry 12 a first region 14 of the shielding sleeve 6 is separated from a second region 15. The two regions 14, 15 are formed by the material of the shielding sleeve 6 and, after their separation, which is preferably realized by shearing, are again arranged on the same surface as before the shearing. This can be clearly seen in FIG. 8. Thus, after the introduction of the crimping geometry 12, the shielding sleeve 6 again forms a largely flat, continuous surface both on the outside and on the inside. The reference number 16 indicates the direction of insertion of the shielding sleeve 6 onto the cable 3, whereas the reference number 17 indicates the direction of insertion of the contact support 2 into the shielding sleeve 6.

FIGS. 9 and 10 show the crimping geometry 12 after crimping. Here, the equal-surface crimping geometry 12, as shown in FIG. 8, has become a locking geometry, as shown in FIGS. 9 and 10. The one region 14, which was not subjected to an external force, was therefore not deformed. In contrast, a force was exerted on the second region 15 in the direction of the central axis of the shielding sleeve 6, so that this region 15 was deformed and optionally also reshaped. It forms a locking edge that interacts with a corresponding geometry of the contact support 2 for the purpose of securing the contact support 2 in the shielding sleeve 6. This geometry can be a cutout, a recess, a circumferential groove, or the like.

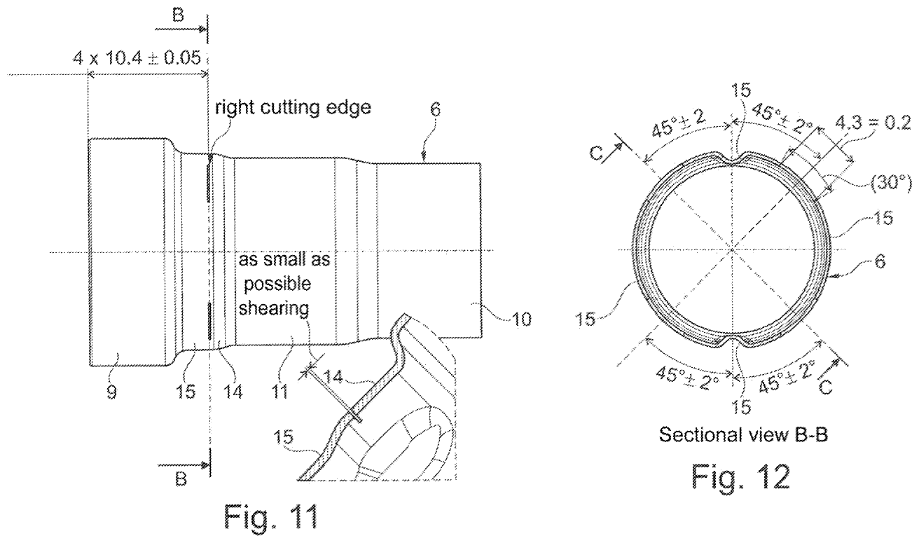

In FIG. 11 (upper larger illustration) it can be seen that the crimping geometry 12 is present at least twice, ideally four times, over the circumference of the shielding sleeve 6. In the smaller lower illustration in FIG. 11 it is shown once again that the shearing between the two regions 14, 15 is as small as possible, i.e. that after the shearing process has taken place, the separated material of the shielding sleeve 6 forms the two regions 14, 15 and their separated end faces facing one another either lie completely or largely against one another or form the smallest possible distance from one another.

FIG. 12 shows a sectional view B-B as shown in FIG. 11. It can be seen that the deformed region 15 of the crimping geometry 12 was not simply deformed in a tab-like manner, but rather underwent a curved deformation when viewed in cross-section. This has already taken place in the upper and lower crimping geometries 12 (as seen in FIG. 12), while the right and left crimping geometries 12, or more precisely their further regions 15, have not yet been deformed (and have not yet been reshaped).

A particularly advantageous crimping of the one region 15 of the crimping geometry 12 can be seen when the outward-facing surface of the further region 15 of the shielding sleeve 6 is not deformed below or at the same height as the inward-facing surface of the not deformed region 14 of the crimping geometry 12. As a result, from a high-frequency technical point of view, no such cutout or passage opening is formed, so that continuous shielding is also effected in this region by means of the shielding sleeve 6, as is also the case with the shielding sleeve 6 in its remaining region around the crimping geometry 12. Of course, the further region 15 can also be deformed (and optionally reshaped) in such a way that its outward-facing surface comes to rest below the inward-facing surface of the not deformed region 14, and, thus, at least a small slot is created between the end regions between the two regions 14, 15. Depending on the high frequency, this slot can be selected so that the shielding remains intact. Optionally, it can also be selected to be larger in order to increase the locking effect, in particular, if the plug connector 1 is not a shielded plug connector.

### LIST OF REFERENCE SIGNS

1. Plug connector
2. Contact support
3. Cable
4. Shielding
5. Line
6. Shielding sleeve
7. Housing
8. Shielding cage
9. Front region
10. Rear region
11. Central region
12. Crimping geometry
13. Studs
14. First region
15. Second region
16. Insertion direction
17. Insertion direction

1.-12. (canceled)

13. A plug connector comprising:
a contact support having at least one contact chamber, wherein a contact partner is inserted in each contact chamber and fixed in its position in the contact chamber; and
a housing into which the contact support is inserted;
wherein a shielding sleeve is coaxially arranged between the housing and the contact support;
wherein the shielding sleeve has at least one crimping geometry; and
wherein a first region of the shielding sleeve is separated from a second region in a region of the at least one crimping geometry.

14. The plug connector according to claim 13, wherein the separation of the first region from the second region is a shear.

15. The plug connector according to claim 13, wherein the at least one crimping geometry is provided several times distributed over a circumference of the shielding sleeve.

16. The plug connector according to claim 13, wherein:
the plug connector is arranged at an end of a cable; and
an end region of the shielding sleeve is arranged around an end region of the cable.

17. The plug connector according to claim 16, wherein the end region of the shielding sleeve is crimped around the end region of the cable.

18. The plug connector according to claim 16, wherein:
the cable has a shielding; and
the shielding sleeve at least partially encloses the shielding of the cable.

19. The plug connector according to claim 18, wherein the shielding sleeve completely encloses the shielding of the cable.

20. The plug connector according to claim 13, wherein a locking of the housing takes place by at least one crimping geometry between the shielding sleeve and the contact support.

21. The plug connector according to claim 20, wherein the shielding sleeve has at least one stud on its outer surface as a crimping geometry.

22. The plug connector according to claim 13, wherein the shielding sleeve has a smooth continuous surface in the direction of the inner contour of the housing.

23. The plug connector according to claim 13, wherein the at least one contact chamber is precisely two contact chambers.

24. The plug connector according to claim 13, wherein the at least one contact chamber comprises more than two contact chambers.

25. A method for installing a plug connector including a contact support having at least one contact chamber, wherein a contact partner is inserted in each contact chamber and fixed in its position in the contact chamber, wherein the plug connector has a housing into which the contact support is inserted, wherein a shielding sleeve is coaxially arranged between the housing and the contact support, wherein the shielding sleeve has at least one crimping geometry, wherein a first region of the shielding sleeve is separated from a second region in the region of the crimping geometry that is deformed relative to the second region in order to secure the shielding sleeve on the contact support.

26. The method according to claim 25, wherein the separation of the first and second regions is achieved by shearing the material of the shielding sleeve.

27. The method according to claim 25, wherein the separation of the first and second regions is achieved by removing the material of the shielding sleeve.

28. The method according to claim 25, wherein after the first and second regions have been separated, the deformation takes place in such a way that the mutually facing end faces of the first and second regions still partially overlap.

29. The method of claim 25, wherein the at least one contact chamber is precisely two contact chambers.

30. The method of claim 25, wherein the at least one contact chamber comprises more than two contact chambers.

31. A method for installing a plug connector including a contact support having at least one contact chamber, the method comprising:
inserting a contact partner in each contact chamber and fixing the contact partner in its position in the contact chamber;
inserting the contact support into a housing of the plug connector has a housing into which the contact support is inserted;
coaxially arranging a shielding sleeve between the housing and the contact support; and
securing the shielding sleeve on the contact support by at least one crimping geometry of the shielding sleeve such that a first region of the shielding sleeve is separated from a second region in the region of the crimping geometry that is deformed relative to the second region.

32. The method according to claim 31, wherein the method includes:
shearing the material of the shielding sleeve to thereby separate the first region of the shielding sleeve from the second region; or
removing the material of the shielding sleeve to thereby separate the first region of the shielding sleeve from the second region.
